(19) United States
(12) Patent Application Publication
(10) Pub. No.: US 2026/0101134 A1
(43) Pub. Date: Apr. 9, 2026

(54) ACOUSTIC DEVICE

(71) Applicant: Panasonic Automotive Systems Co., Ltd., Kanagawa (JP)

(72) Inventors: Toyohiro TANI, Kanagawa (JP); Toru MUGIUDA, Osaka (JP)

(73) Assignee: Panasonic Automotive Systems Co., Ltd., Kanagawa (JP)

(21) Appl. No.: 19/350,788

(22) Filed: Oct. 6, 2025

(30) Foreign Application Priority Data
Oct. 8, 2024 (JP) 2024-176462

(51) Int. Cl. H04R 1/28; H04R 1/06; H04R 17/00

(52) U.S. Cl. CPC H04R 1/2811; H04R 1/06; H04R 1/2888; H04R 17/00; H04R 2499/13

(57) ABSTRACT

An acoustic device according to the present disclosure includes the following: a substrate including a circuit for generating a drive signal; an acoustic output element that generates sound waves in response to the drive signal; an acoustic film that is connected to the acoustic output element and diffuses the sound waves, and a housing for housing the substrate, the acoustic device, and the acoustic film therein. The substrate is provided so as to divide a space in the housing into an upper cavity and a lower cavity, the upper cavity and the lower cavity communicate with each other through an opening portion, and the opening portion includes a substrate opening portion that penetrates the substrate.

### TECHNICAL FIELD

The present disclosure relates to an acoustic device, and more particularly, to an acoustic device used for outputting a warning sound in an in-vehicle device.

### BACKGROUND ART

In recent years, in the in-vehicle device, an acoustic device that generates a warning sound for theft prevention or improvement of safety has been studied. In acoustic devices, frequency characteristics and a sound pressure are factors that determine sound performance. The audible frequency range that can be heard by a human is 20 Hz to 20,000 Hz (20 kHz), whereas the frequency of the sound of an existing warning alarm is set in a range of 2 kHz to 4 kHz. This is because the human ear is highly sensitive and easily hears sounds in the range of 2 kHz to 4 kHz. Therefore, the warning alarm is designed to have a large sound pressure in this frequency band so that the sound can travel farther.

### CITATION LIST

### Patent Literature

PTL 1
Japanese Patent No. 6872723

### SUMMARY OF INVENTION

### Technical Problem

In an existing acoustic device, when a warning sound in the frequency band of 2 kHz to 4 kHz is output, the sound pressure may be decreased near a predetermined frequency. This may result in the sound in that frequency band being weak, and for example, in a noisy environment, the alarm sound may be difficult to recognize. In addition, since the frequency characteristics may be non-uniform, the sound may be felt to be discontinuous, and it may be difficult to convey the urgency as a warning sound to a listener.

A non-limiting objective of the present disclosure is to provide an acoustic device that suppresses a decrease in sound pressure near a predetermined frequency.

### Solution to Problem

An acoustic device according to an embodiment of the present disclosure includes: a substrate including a circuit that generates a drive signal for generating a sound wave; and a housing for housing the substrate inside, in which the substrate is provided at a position that divides a space in the housing into an upper cavity and a lower cavity, the upper cavity and the lower cavity communicate with each other through an opening portion, and

the opening portion includes a substrate opening portion that penetrates the substrate.

### Advantageous Effects of Invention

According to the present disclosure, it is possible to suppress the decrease in the sound pressure near a predetermined frequency.

### BRIEF DESCRIPTION OF DRAWINGS

FIG. 1 is a cross-sectional view of an acoustic device according to Embodiment 1, and is a cross-sectional view taken along the B-B′ cross section in FIG. 2;

FIG. 2 is a cross-sectional view taken along the A-A′ cross section in FIG. 1;

FIG. 3A is a conceptual view of a gap between a housing and a substrate, and a substrate opening portion;

FIG. 3B is a conceptual view of a gap between a housing and a substrate, and a substrate opening portion;

FIG. 4 is a diagram for describing opening area ratios;

FIG. 5 is a graph illustrating the dependency of the opening area ratio for the sound pressure improvement rate near 3.0 kHz;

FIG. 6 is a graph illustrating the dependency of the opening area ratio for the sound pressure improvement rate of the maximum sound pressure;

FIG. 7 is a graph illustrating the dependency of the opening area ratio for the sound pressure improvement rate of the maximum sound pressure in the sweep control of 2.6 kHz to 3.5 kHz; and

FIG. 8 is a graph illustrating the sound pressure near 3.0 KHz.

### DESCRIPTION OF EMBODIMENTS

Hereinafter, the embodiments of the present disclosure will be described in detail with reference to the drawings as appropriate. However, more detailed explanation than necessary may be omitted. For example, detailed explanation of well-known matters or duplicate explanations of substantially the same configurations may be omitted. This is to avoid the following explanation becoming unnecessarily redundant and to facilitate understanding by those skilled in the art.

It should be noted that the accompanying drawings and the following description are provided to enable those skilled in the art to fully understand the present disclosure, and are not intended to limit the subject matter described in the claims.

Acoustic device 1 according to an embodiment may be used, for example, as a self-powered siren. The self-powered siren is a type of siren used in a security system of a vehicle and may be operated when an abnormality in a vehicle is detected. Since the siren can operate with a self-power supply without depending on an external power supply, it is possible to issue a warning even when the battery of the vehicle is dead. The siren is linked to another sensor, such as an intrusion sensor or a tilt sensor, to detect intrusion into the vehicle, theft of a tire, or the like, and to issue a powerful sound to deter intrusion. Acoustic device 1 is not limited to the self-powered siren, and may be used as a siren of a security system in various places, such as a house, an office, a store, a commercial facility, or a public facility.

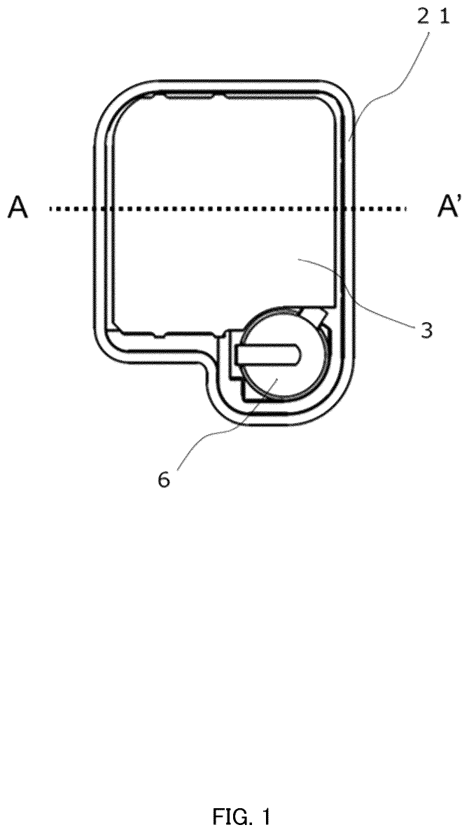

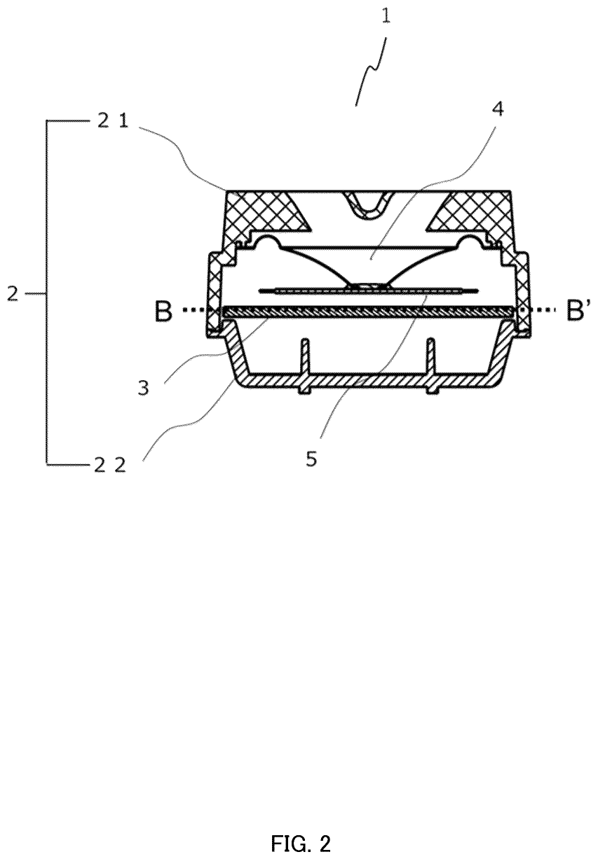

FIG. 1 is a cross-sectional view of an acoustic device according to Embodiment 1. FIG. 2 is a cross-sectional view taken along the A-A′ cross section in FIG. 1. As illustrated in the drawings, acoustic device 1 includes substrate 3, acoustic output element 5, acoustic film 4, battery 6, and housing 2 that houses these components.

### (Housing 2)

As illustrated in FIGS. 1 and 2, acoustic device 1 includes housing 2 that provides a space for housing substrate 3 and a space for housing battery 6. Housing 2 is composed of upper housing 21 and lower housing 22, and is a member for protecting the components or a circuit board housed therein and for blocking the influence from the external environment. Housing 2 is designed in consideration of mechanical strength and environmental resistance, and is configured to protect the internal electronic components from external vibrations, impacts, humidity, dust, and the like. Housing 2 provides a space or a cavity for efficiently disposing the components or wiring.

As a material of housing 2, a resin or a metal having excellent durability and heat resistance and being lightweight may be adopted. For example, housing 2 is made of a polybutylene terephthalate (PBT) resin. A PBT resin has excellent impact resistance, heat resistance, and chemical resistance, and further achieves high mechanical strength. By adopting such a material, housing 2 has high durability against external environmental influences and provides stable performance for a long period of time.

Housing 2 may include a connector for electrical connection to an external power supply, such as an in-vehicle battery. Housing 2 may include a connector for receiving a siren activation command and a siren stop command.

As illustrated in FIG. 2, a ring-shaped opening for radiating sound waves outward is provided on the upper surface of upper housing 21 of housing 2. The inner diameter of the inner surface of the ring-shaped opening increases upward. In addition, a recessed member having a substantially conical shape and whose inner diameter increases upward is provided in the opening. A ring-shaped slit that provides a path through which sound waves pass is provided between the recessed member having a substantially conical shape and the inner surface of upper housing 21 having a substantially conical shape. By providing the substantially conical-shaped slit whose outer shape and inner diameter increase upward, the radiation direction of the sound waves to the outside is expanded, and the sound waves can be diffused over a wide range. The direction in which sound waves are emitted can be controlled by changing the width, angle, and shape of the slit, making it possible to concentrate the sound in a specific direction or to disperse the sound over a wide range. The ring-shaped slit may be divided into a plurality of regions. The opening for radiating the sound waves outward is not limited to a ring shape. The opening for radiating the sound waves to the outside may be, for example, the following: a horn-shaped or a bell-shaped opening, such as a portion that is expanded at the tip of a trumpet; a porous structure in which a plurality of small holes is provided on the surface of a case to disperse the sound waves in a plurality of directions, thereby diffusing the sound waves to the outside; a grill structure in which a grill-shaped opening portion is provided in a case to allow sound waves to spread evenly to the outside; or a duct structure in which a sound duct is provided in a case.

A structure for supporting the outer edge portion of acoustic film 4 may be provided on the inner surface of upper housing 21 of housing 2. For example, the inner surface of upper housing 21 may be provided with a support rib for supporting the outer edge portion of acoustic film 4, a clamp structure for clamping acoustic film 4, a flange for adhering acoustic film 4, a snap fit structure for making acoustic film 4 detachable, or the like.

As illustrated in FIG. 2, lower housing 22 of housing 2 includes a bottom portion, a side portion, and a flange portion that extends from the side portion in the outer peripheral direction. The height of the edge of the side portion is higher than the height of the flange portion contacting the end of the side portion of upper housing 21. By increasing the height of the edge, the adhesion to upper housing 21 is improved, and the strength, the assembly accuracy, and the airtightness can be increased.

Upper housing 21 and lower housing 22 may be connected to each other by a snap fit structure such that one of upper housing 21 and lower housing 22 is provided with a plurality of projections (snaps), and the other one is provided with recesses (fits). In addition, upper housing 21 and lower housing 22 may be provided with screw holes, thereby fixing upper housing 21 and lower housing 22 with screws. Further, upper housing 21 and lower housing 22 may be bonded using an adhesive to achieve satisfactory airtightness.

### (Substrate 3)

Substrate 3 is a board for physically supporting the electronic components and electrically connecting the electronic components. Substrate 3 may be, for example, a single-sided board with a wiring pattern provided on one surface thereof and components mounted on the other surface, a double-sided board with wiring pattern provided on both surfaces of the board and through-holes that allow the front wiring and back wiring to be connected to each other, or a multilayer board with a plurality of wiring layers. A pad or a through-hole (which does not penetrate all the way through substrate 3) for fixing or connecting the electronic components may be provided on substrate 3. Examples of the electronic component include a drive circuit that drives a piezoelectric buzzer, a control circuit that controls the drive circuit, and a switch that switches a power supply from an external power supply to an internal battery. Substrate 3 may be supplied with power from the external power supply through the connector provided in housing 2 or from internal battery 6 housed inside acoustic device 1, or the external power supply and the internal power supply may be configured to be switchable.

In order to connect housing 2 to substrate 3, housing 2 has a structure for physically stably fixing substrate 3. This connection structure provides a means for reliably holding substrate 3 within the housing and for appropriately performing an electrical connection to the outside of the housing.

A plurality of fixing projections for supporting substrate 3 may be provided inside lower housing 22. The plurality of fixing projections are provided at predetermined positions of substrate 3 and are disposed to align with the mounting holes of substrate 3. Substrate 3 is fixed while the projections are fitted into the mounting holes, and is held in the housing by, for example, a retainer or a snap fit structure provided on the projections.

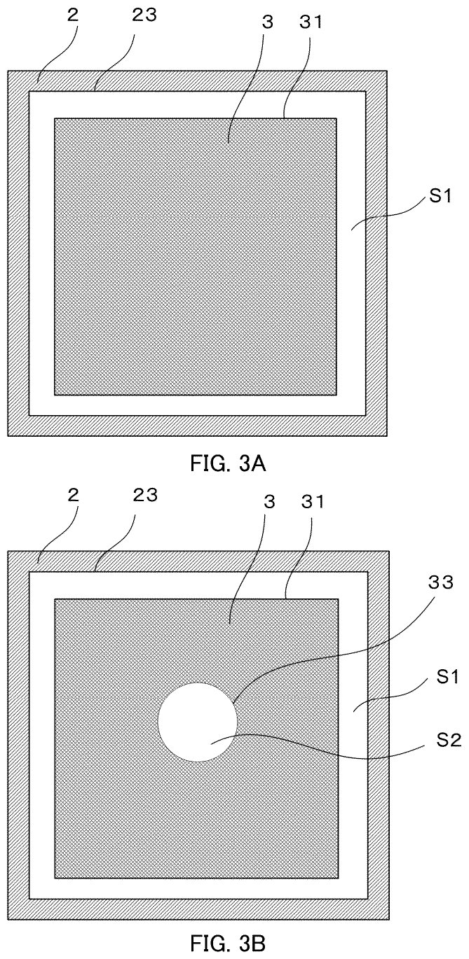

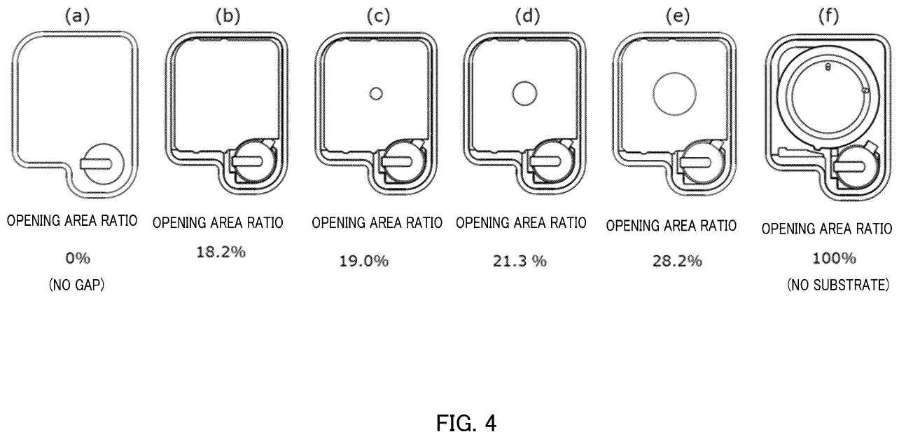

In FIGS. 1 and 2, substrate opening portion 33 provided in substrate 3 is not illustrated. Substrate opening portion 33 will be described with reference to FIGS. 3 and 4 to be described below.

### (Acoustic Output Element 5)

Acoustic output element 5 is, for example, a piezoelectric buzzer. A piezoelectric buzzer is composed of a piezoelectric element and a diaphragm, and these elements work together to generate sound waves. The piezoelectric element converts electrical energy from a power supply into mechanical vibration by using a piezoelectric effect. The piezoelectric element is disposed on the diaphragm and is disposed to sandwich the diaphragm from above and below. The diaphragm and the piezoelectric element each have a substantially circular plate shape with the centers thereof on the same axis, and the diameter of the diaphragm is larger than the diameter of the piezoelectric element. When a driving voltage is applied to the piezoelectric element, an electric field is generated in the piezoelectric element, the piezoelectric element itself is deformed in response to the electric field by the piezoelectric effect, and repeats minute extension and contraction motions. The extension and contraction motion becomes a mechanical vibration, and the vibration is transmitted to the diaphragm. When the diaphragm vibrates, it pushes and pulls the surrounding air to cause fluctuations in air pressure. These air pressure fluctuations become the source of sound waves. Then, the sound waves propagate in the surrounding air and spread out as pressure waves.

Substrate 3 is provided with a drive circuit for controlling the piezoelectric element and wiring for transmitting a drive signal to the piezoelectric element. The drive signal is transmitted to the piezoelectric element via the drive circuit. The drive circuit controls the piezoelectric element to operate at an appropriate frequency and amplitude, and electrically determines the frequency of the sound waves. In the embodiment of the present application, acoustic output element 5 is configured to emit sound waves having a frequency at least in a range of 2 kHz to 4 kHz.

### (Acoustic Film 4)

Acoustic film 4 is made of a thin film material formed to have a conical shape, and plays a role of efficiently transmitting and diffusing sound in the acoustic device. Acoustic film 4 has high followability with respect to a piezoelectric plate or a diaphragm, and radiates sound waves to the outside.

Acoustic film 4 has a truncated cone shape. Acoustic film 4 includes a bottom portion having a substantially circular shape, a side portion having an inverted cone shape or a horn or a bell shape, and a flange portion extending from the outer edge of the side portion. The diameter of the side portion increases upward from the bottom portion.

The bottom portion of acoustic film 4 is connected to the diaphragm or the piezoelectric element of acoustic output element 5 by an adhesive or the like to transmit the vibration from acoustic output element 5 to the side portion of acoustic film 4. The outer peripheral edge of the flange portion of acoustic film 4 is fixed to the inner surface of housing 2. A protrusion for weakening the transmission of the vibration to housing 2 is provided on the flange portion of acoustic film 4. The protrusion is for suppressing the vibration of acoustic film 4 before the vibration is transmitted to housing 2, and plays a role in suppressing the transmission of vibration energy and confining the vibration inside the protrusion. The protrusion is disposed in a ring shape between the outer peripheral edge of the flange portion and the side portion of acoustic film 4.

Acoustic film 4 may be made of lightweight and high-rigidity material, such as a synthetic resin. The thickness of acoustic film 4 is set to provide acoustic film 4 appropriate rigidity and flexibility, and may be set to appropriately transmit the vibration from the diaphragm.

### (Substrate Opening Portion 33)

Substrate opening portion 33 provided in substrate 3 will be described with reference to FIG. 3. FIG. 3A is a cross-sectional view of a reference example in which substrate opening portion 33 is not provided in substrate 3. In the reference example, there is a gap having an opening area S1 between the region surrounded by inner circumferential surface 23 of housing 2 and the region surrounded by outer surface 31 of substrate 3. Such a gap may be provided by the following reasons. In an existing acoustic device, there is a manufacturing tolerance in the dimensions of housing 2 and substrate 3, making it difficult to accurately bring housing 2 and substrate 3 into close contact with each other, and a certain degree of gap is required in the design. In addition, in an existing acoustic device, a small gap is provided between substrate 3 and housing 2 to allow smooth insertion and removal of substrate 3 during housing of substrate 3 into housing 2. Further, in an existing acoustic device, the presence of the gap allows the generation of an air flow around substrate 3, enabling internal heat to be efficiently dissipated. A gap is provided between housing 2 and substrate 3 in such a way that the impact or the vibration from the outside is suppressed before being transmitted to substrate 3. In an existing acoustic device, the upper cavity and the lower cavity, which are separated vertically with substrate 3 therebetween, communicate with each other through the gap having the opening area S1.

FIG. 3B is a cross-sectional view of acoustic device 1 according to the embodiment of the present application. As illustrated in FIG. 3B, in addition to the gap having the opening area S1, substrate 3 is provided with substrate opening portion 33 that penetrates substrate 3. Substrate opening portion 33 has an opening area S2. Substrate opening portion 33 is provided to reduce the resonance loss in the upper cavity and the lower cavity.

### (Shape of Substrate Opening Portion 33)

The shape of substrate opening portion 33 will be described. With regard to the shape of the substrate opening portion 33, substrate opening portion 33 may be a circular opening, as illustrated in FIG. 3B. A circular shape reduces stress concentration and is easy to manufacture. In addition, sound waves can be evenly diffused, and the resonance loss can be effectively suppressed. The shape of substrate opening portion 33 is not limited to a circle, and may be another shape. For example, substrate opening portion 33 may be a rectangular or square opening. Rectangular or square opening can aim for a resonance suppression effect on a specific frequency band, but stress concentration is more likely to occur, which may affect the strength of substrate 3. Further, substrate opening portion 33 may be a polygonal opening. A shape with a plurality of corners (a hexagon, and the like) may exhibit an effect in a specific frequency band.

### (Number of Substrate Opening Portions 33)

The number of the substrate opening portions 33 may be arbitrary. As an example, by providing a single relatively large opening, the resonance loss can be effectively suppressed, but on the other hand, there is a possibility that the strength of substrate 3 becomes insufficient. Alternatively, a plurality of openings may be provided. By providing a plurality of openings, the resonance loss can be further reduced. Increasing the number of openings can increase the fluidity of sound waves throughout substrate 3, and the generation of the resonance loss can be suppressed. However, when the number of the openings is too large, the strength of substrate 3 is affected, and therefore, it is desirable to design the number of the openings in consideration of the balance with the strength.

### (Position of Substrate Opening Portion 33)

Substrate opening portion 33 may be positioned anywhere as long as the function of the circuit mounted on substrate 3 is not impaired. As an example, substrate opening portion 33 may be disposed at the center portion of substrate 3. By providing an opening at the center of substrate 3, the flow of sound waves can be improved in a region where the vibration of the piezoelectric element is relatively large, and the resonance loss can be effectively suppressed. However, the center portion is desirably designed to have an appropriate strength in consideration of the structure of substrate 3. In addition, at least one substrate opening portion 33 may be disposed on the peripheral portion of substrate 3. By providing a plurality of small openings in the peripheral portion of substrate 3, the resonance generated in the edge portion can be suppressed, and the overall resonance characteristics can be improved. Further, substrate opening portions 33 may be randomly disposed. By randomly disposing the substrate opening portions 33, the resonance in a specific frequency band can be dispersed, and uniform sound characteristics can be obtained over a wide frequency band.

### (Opening Area Ratio)

The method of obtaining the opening area ratio will be described with reference to FIGS. 3A and 3B. The opening area ratio is obtained by (S1+S2)/S0×100, and the unit of the opening area ratio is [%].

Here, S0 is an area of a closed region surrounded by inner circumferential surface 23 of the housing, S1 is an area of a gap between inner circumferential surface 23 of the housing and outer surface 31 of the substrate, and S2 is an opening area of substrate opening portion 33 provided in substrate 3.

Next, the opening area ratio will be described with reference to reference examples and examples using FIG. 4.

Part (a) in FIG. 4 illustrates a case of the opening area ratio being 0%, for example, a cross section of Reference Example 1 in which neither the gap having S1 nor substrate opening portion 33 having S2 is provided. In this case, the upper cavity and the lower cavity defined in upper and lower parts with substrate 3 therebetween substantially do not communicate with each other. Therefore, the opening area ratio is 0%.

Part (b) in FIG. 4 illustrates a cross section of Reference Example 2 in which a gap having area S1 is provided, but substrate opening portion 33 is not provided in substrate 3. Here, S2 is 0. In this case, the opening area ratio is determined based on S1, and the opening area ratio is 18.2%.

Part (c) in FIG. 4 illustrates a cross section of Example 1 in which substrate opening portion 33 having a diameter of 5 mm and penetrating substrate 3 is provided in addition to a gap having the same area S1 as in part (b) in FIG. 4. The opening area ratio is 19%.

Part (d) in FIG. 4 illustrates a cross section of Example 2 in which substrate opening portion 33 having a diameter of 10 mm and penetrating substrate 3 is provided in addition to a gap having the same area S1 as in part (b) in FIG. 4. The opening area ratio is 21.3%.

Part (e) in FIG. 4 illustrates a cross section of Example 3 in which substrate opening portion 33 having a diameter of 25.24 mm and penetrating substrate 3 is provided in addition to a gap having the same area S1 as in part (b) in FIG. 4. The opening area ratio is 28.2%.

Part (f) in FIG. 4 illustrates a cross section of Reference Example 3 that includes no substrate 3. Since there is no substrate and S1+S2=S0, the opening area ratio is 100%.

The opening area ratio is obtained by, for example, the following calculation: a geometric calculation that calculates the area based on the dimensions and the shape of the opening portion; a calculation using CAD software or 3D modeling tool; or a calculation by manual measurement of the size.

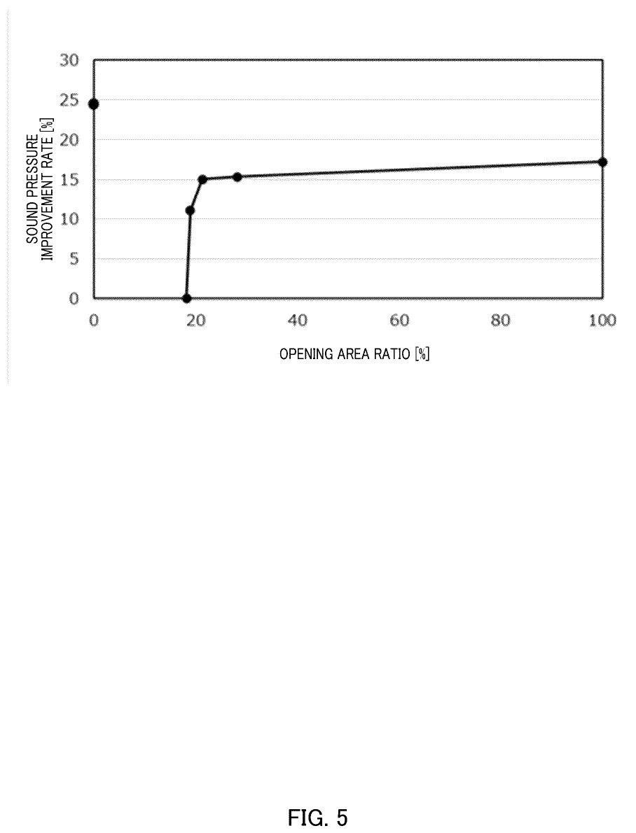

The acoustic effect of substrate opening portion 33 provided in substrate 3 will be described with reference to Tables 1 to 3 and FIGS. 5 to 8 below.

TABLE 1

| | Reference | Reference | | | | Reference |
|---|---|---|---|---|---|---|
| | Example 1 | Example 2 | Example 1 | Example 2 | Example 3 | Example 3 |
| Presence or Absence | Absence | Presence | Presence | Presence | Presence | — |
| of Gap | | | | | | |
| Diameter (mm) of | — | — | φ5 | φ10 | φ25.24 | — |
| Substrate Opening | | | | | | |
| Portion 33 | | | | | | |
| Opening Area Ratio | 0 | 18.2 | 19.0 | 21.3 | 28.2 | 100 |
| [%] | | | | | | |
| Sound Pressure [dBA] | 113.20 | 111.27 | 112.18 | 112.49 | 112.51 | 112.65 |
| at Frequency near 3.0 | | | | | | |
| kHz | | | | | | |
| Difference [dBA] | 1.93 | 0.00 | 0.91 | 1.22 | 1.24 | 1.38 |
| (increase ratio) with | (24.8%) | (0%) | (11%) | (15%) | (15.3%) | (17.2%) |
| respect to Reference | | | | | | |
| Example 2 | | | | | | |

Table 1 will be used to describe the amount of improvement in the dip near 3.0 kHz in the frequency characteristics of the reference examples and the examples of the present application illustrated in parts (a) to (f) in FIG. 4. The dip is a portion in which the sound pressure is decreased in the frequency characteristic.

In the left column of Table 1, the presence or absence of the gap represents whether there is a gap having area S1 in FIG. 4. The absence of the gap indicates that area S1 in FIG. 4 is 0. The diameter (mm) of substrate opening portion 33 represents the size of the diameter of circular substrate opening portion 33 having a circular shape and penetrating substrate 3. The opening area ratio [%] indicates the ratio of the area of the opening portion provided in substrate 3 to the area of the entire substrate 3.

In the left column of Table 1, the sound pressure [dBA] at the frequency near 3.0 kHz indicates the sound pressure level measured for a sound wave having the frequency near 3.0 kHz. The sound pressure is a physical quantity indicating the magnitude of the pressure fluctuations that occur when the sound wave travels through air or another medium, and is represented in decibels (dBA). A higher numerical value means a higher sound pressure. In a warning sound, the sound pressure is one of the parameters. For example, when the sound pressure is high, the warning sound is easily heard even in an environment with a lot of noise, the warning sound is effectively transmitted over a wide range, the urgency is easily felt intuitively, and the warning sound is less likely to be blocked by a building or the like. In the left column of Table 1, a difference [dBA] (ratio) near 3 kHz with respect to Reference Example 2 indicates a difference in sound pressure level when compared to Reference Example 2. Here, the increase amount and the increase ratio of the sound pressure are represented in decibels (dBA) and a ratio with respect to Reference Example 2. A larger numerical value means larger improvement in the sound pressure.

### Reference Example 2

Reference Example 2 corresponds to the case illustrated in part (b) in FIG. 4. In Reference Example 2 in which the opening area ratio is 18.2%, the sound pressure of 3.0 kHz is 111.27 dBA, and other reference examples and examples are compared with this sound pressure as a reference.

### Example 1: φ5

Example 1 corresponds to a case where circular substrate opening portion 33 having a diameter of 5 mm and penetrating the substrate is provided. Providing the circular opening portion having a diameter of 5 mm corresponds to an opening area ratio of 19.0%. In this case, the sound pressure becomes 112.18 dBA, which presents an improvement of 0.91 dBA (11%) as compared with Reference Example 2. This indicates that the sound pressure can be improved by increasing the opening area by 0.8% as compared with Reference Example 2.

### Example 2: φ10

Example 2 corresponds to a case where a circular opening portion having a diameter of 10 mm and penetrating substrate 3 is provided. Providing the circular opening portion having a diameter of 10 mm corresponds to an opening area ratio of 21.3%. In this case, the sound pressure becomes 112.49 dBA, which represents an improvement of 1.22 dBA (15%) as compared with Reference Example 2. This indicates that the increase in the opening area contributes to further improvement in the sound pressure.

### Example 3: φ25.24

Example 3 corresponds to a case where a circular opening portion having a diameter of 25.24 mm and penetrating substrate 3 is provided. Providing the circular opening portion having a diameter of 25.24 mm corresponds to an opening area ratio of 28.2%. In this case, the sound pressure reaches 112.51 dBA, and an improvement of 1.24 dBA (15.3%) was observed as compared to Reference Example 2. In this case, the increase in the opening area has a positive influence on the sound characteristics, but the degree of the improvement is substantially the same as in a case of φ10.

### Reference Example 3

Reference Example 3 corresponds to a case where substrate 3 is not provided. Although it is not realistic to not provide substrate 3, by not providing substrate 3, the influence of substrate 3 on the sound characteristics can be eliminated. When substrate 3 is present, there is a possibility that the propagation or the resonance of the sound wave may be affected by the material or the shape of substrate 3, and by removing substrate 3, the influence can be avoided and the pure sound characteristic can be measured. By evaluating the sound characteristics while there is no substrate 3, it is possible to understand what type of influence substrate 3 has on the entire acoustic device. When there is no substrate 3, the sound pressure reaches 112.65 dBA, and an improvement of 1.38 dBA (17.2%) is confirmed as compared with Reference Example 2.

Here, in a case of Example 3 (φ25.24, opening area ratio of 28.2%) and a case of Reference Example 3 (opening area ratio of 100%), although the opening area ratio is approximately 3.5 times higher in Reference Example 3, no significant difference was observed between the two examples in the improvement from Reference Example 2. In the housing of “φ25.24”, the opening portion is provided in the substrate, and the opening portion area ratio is 28.2%. With this opening portion, the substrate does not completely divide the space in the housing, and the upper and lower spaces partially communicate with each other. This partial communication alleviates the influence on the sound characteristics due to the presence of the substrate itself, and the sound pressure of sound wave can become close to that in the case where there is “no substrate”. As a result, it is considered that the resonance of the space or the decrease in the sound pressure is suppressed by the opening portion even though the substrate is present, and the same sound characteristic as in the case where there is “no substrate” is obtained. In addition, by providing the opening portion, the acoustic disadvantage due to the division of the space by a substrate is reduced. The resonance loss due to the presence of a substrate can be minimized and the sound pressure can be improved, and characteristics similar to those obtained in a case where the substrate is not present can be exhibited. It is considered that the resonance loss can be effectively reduced at the stage of the φ5 case.

### Reference Example 1: Gap Having Area S1 is not Present

Reference Example 1 in the rightmost column of Table 1 corresponds to a case where the gap in the housing is completely eliminated. For example, Reference example 1 corresponds to a case where the upper cavity and the lower cavity are spatially isolated from each other with a substrate therebetween. In the case where there is “no gap”, the sound pressure reached 113.20 dBA, and the maximum improvement of 1.93 dBA (24.8%) was confirmed with respect to the reference example 2 serving as a reference. In this case, since the upper and lower cavities do not communicate with each other, it is considered that the resonance loss between the upper and lower cavities and the leakage of the sound waves from the upper cavity to the lower cavity does not occur, and the sound pressure becomes the largest among all the examples.

The amount of improvement in the dip near 3.0 kHz in the frequency characteristics of Table 1 will be described in more detail with reference to the graph in FIG. 5.

The horizontal axis of FIG. 5 is an opening area ratio (%). As the opening area ratio increases, the ratio occupied by substrate 3 decreases and the area (S1+S2) increases. The vertical axis of FIG. 5 is an amount of improvement in the sound pressure near 3.0 kHz. The amount of improvement is shown as a percentage, and the larger the value, the more the sound pressure is improved as compared with the reference example 2 serving as a reference.

As illustrated in FIG. 5, the sound pressure improvement rate sharply increases once the opening area exceeds around 18.2%, then becomes gentle near the opening area of 21.3% corresponding to Example 2, and remains substantially flat until the opening area of 100% corresponding to Reference Example 3. This result suggests that the improvement effect on the sound pressure is saturated when the opening area reaches approximately 21.3%, and that it is difficult to achieve significant improvement by further increasing the area.

When the opening area ratio exceeds approximately 28%, a slight increase in the sound pressure improvement rate is observed, but the improvement is small and no significant effect can be obtained, indicating that there is a limit to the effect of increasing the opening area.

From the graph in FIG. 5, it can be seen that appropriately setting the opening area affects the improvement of the sound characteristics, and thus by selecting the optimal opening area, it is possible to avoid the wasteful design change such as providing substrate opening portion 33 that is unnecessarily large. For example, providing substrate opening portion 33 that is unnecessarily large may require a redesign of an existing substrate 3 or the size reduction of the circuit element to be used in the existing substrate 3, and thus may require a significant change to the existing substrate 3. On the basis of the graph illustrated in FIG. 5, it is possible to adjust the existing substrate 3 to obtain the optimal sound characteristics without making an overall design change. As described above, by using the result obtained from the graph in FIG. 5, the performance of the acoustic device can be improved while the design change of the entire substrate 3 is minimized by appropriately setting the substrate opening portion 33. As a result, the design efficiency is improved and the cost is reduced. For example, from the graph in FIG. 5, in consideration of the balance between the sound performance and other design requirements, it is considered that the opening area range of 19% or more and 28.2% or less, in which appropriate improvement can be obtained, is a practical design choice.

In the graph of FIG. 5, in Reference Example 1 in which the opening area ratio is 0%, for example, a large improvement rate is obtained as compared with other examples. However, in order to eliminate the gap between the inner surface of housing 2 and substrate 3, it is desirable to use a precise manufacturing technique. The components are assembled with high precision in the manufacturing technique, and the manufacturing cost may be significantly increased. In addition, since additional material or additional work time is needed to fill the gap, the manufacturing technique is not efficient for performing mass production. On the other hand, providing substrate opening portion 33 is cost-effective because it is easy to accommodate at the design stage and can be implemented without making major changes to the existing manufacturing process. By installing the substrate opening portion 33, it is possible to avoid a complex step of filling the gap and to maintain a balance between the speed and the cost of manufacturing. Further, by providing substrate opening portion 33 in substrate 3, the design freedom is increased. It is possible to finely adjust and optimize the sound characteristics by adjusting the number, the size, or the shape of the substrate opening portion(s) 33. This provides flexibility for responding to different acoustic requirements, and enables customization according to a specific use environment or requirement. The method of providing substrate opening portion 33 is suitable for mass production and can maintain stable quality even when a large number of substrates with the same design is produced. Providing substrate opening portion 33 requires fewer changes to the manufacturing process and is easy to scale up. In contrast, the step of filling the gap is time-consuming and may cause instability in mass production. In addition, in a case of filling a gap, performance may vary from product to product depending on how well the gap is filled. On the other hand, substrate opening portion 33 of substrate 3 can be designed to provide consistent products. Depending on the material used to fill a gap, deterioration or shrinkage of the material may occur over time, which may affect the sound characteristics. When substrate opening portion 33 is provided in substrate 3, the risk of such deterioration is smaller.

According to the graph in FIG. 5, the structure of Reference Example 1 in which there is “no gap” provides the highest sound pressure. However, achieving such a structure requires a lot of cost and effort. Therefore, providing substrate opening portion 33 in substrate 3 may be a more realistic and practical option for mass-produced products, as such a configuration has a simpler manufacturing process, is more cost-effective, and provides greater design flexibility. Even by the method, sufficient acoustic performance improvement can be obtained, and therefore, it can be said that “providing the opening portion” is a better approach than “filling the gap” in the manufacturing of an acoustic device.

TABLE 2

| | Reference | Reference | | | | Reference |
|---|---|---|---|---|---|---|
| | Example 1 | Example 2 | Example 1 | Example 2 | Example 3 | Example 3 |
| Presence or | Absence | Presence | Presence | Presence | Presence | — |
| Absence of Gap | | | | | | |
| Diameter (mm) of | — | — | φ5 | φ10 | φ25.24 | — |
| Substrate Opening | | | | | | |
| Portion 33 | | | | | | |
| Opening Area | 0 | 18.2 | 19.0 | 21.3 | 28.2 | 100 |
| Ratio [%] | | | | | | |
| Sound Pressure | 115.28 | 114.42 | 114.91 | 115.03 | 115.12 | 115.24 |
| [dBA] | | | | | | |
| Difference [dBA] | 0.86 | 0.00 | 0.49 | 0.61 | 0.70 | 0.82 |
| (ratio) with respect | (10.4%) | (0%) | (5.8%) | (7.2%) | (8.4%) | (9.9%) |
| to Reference | | | | | | |
| Example 2 | | | | | | |

Table 2 will be used to describe the amount of improvement in the maximum sound pressure in the frequency characteristics at a frequency of approximately 3.1 kHz to 3.2 kHz. Specifically, the change in the sound pressure level based on different design conditions (the opening area ratio, the presence or absence of substrate 3, and the presence or absence of the substrate opening portion) is compared with the improvement effect with respect to the reference example 2 serving as a reference.

In the leftmost column of Table 2, the presence or absence of the gap, the diameter (mm) of the substrate opening portion 33, and the opening area ratio [%] are the same as those in Table 1. In the leftmost column of Table 2, the sound pressure [dBA] represents the measured maximum sound pressure level in decibels (dBA). A higher sound pressure level means a higher sound pressure of the sound radiated from the acoustic device. In the leftmost column of Table 2, the difference in maximum sound pressure [dBA] (ratio) indicates a difference in sound pressure level when compared to the reference example 2 used as a reference, and is displayed in decibels (dBA) and an increase ratio (%). A higher numerical number means a more improved sound pressure.

### Reference Example 2

In the reference example in which the opening area ratio is 18.2%, the maximum sound pressure is 114.42 dBA. Other design conditions are compared with this value as a reference.

### Example 1: φ5

When the opening area ratio is 19.0%, the maximum sound pressure is 114.91 dBA, and an improvement of 0.49 dBA (5.8%) is observed as compared with Reference Example 2. This indicates that the sound pressure is slightly improved by slightly increasing the opening area.

### Example 2: φ10

When the opening area ratio is 21.3%, the maximum sound pressure reaches 115.03 dBA, and an improvement of 0.61 dBA (7.2%) is confirmed as compared with Reference Example 2. Further, the improvement in the sound pressure was confirmed by increasing the opening area.

### Example 3: φ25.24

When the opening area ratio is 28.2%, the maximum sound pressure is 115.12 dBA, and an improvement of 0.70 dBA (8.4%) is confirmed as compared with Reference Example 2. In this case, the improvement effect by increasing the opening area is further enhanced.

### Reference Example 3

In a case where substrate 3 is not provided, the maximum sound pressure reaches 115.24 dBA, and an improvement of 0.82 dBA (9.9%) is confirmed. The sound pressure is further increased since there is no influence of substrate 3.

### Reference Example 1

In a case of Reference Example 1 in which there is “no gap”, the maximum sound pressure reaches 115.28 dBA, and the greatest improvement of 0.86 dBA (10.4%) is confirmed with respect to Reference Example 2. In this case, since there is no leakage of the sound wave or resonance loss between the upper and lower cavities, the highest sound pressure is obtained.

From Table 2, it is clear that the maximum sound pressure of the acoustic device is improved by increasing the opening area of substrate 3. The improvement effect of the sound pressure tends to be higher as the opening area is larger, but it is suggested that there is a limit to the improvement effect after the opening area is increased by a certain amount or more.

In this regard, it can be seen that the above results are consistent with the results of Table 1 and the graph of FIG. 5. Among them, the most effective is to completely eliminate the gap, and in this case, the maximum sound pressure improvement is achieved. However, as described above, since it is difficult to eliminate the gap and to bring the components into close contact with each other in manufacturing, it is more appropriate to provide substrate opening portion 33 in substrate 3 to achieve practical and effective sound pressure improvement.

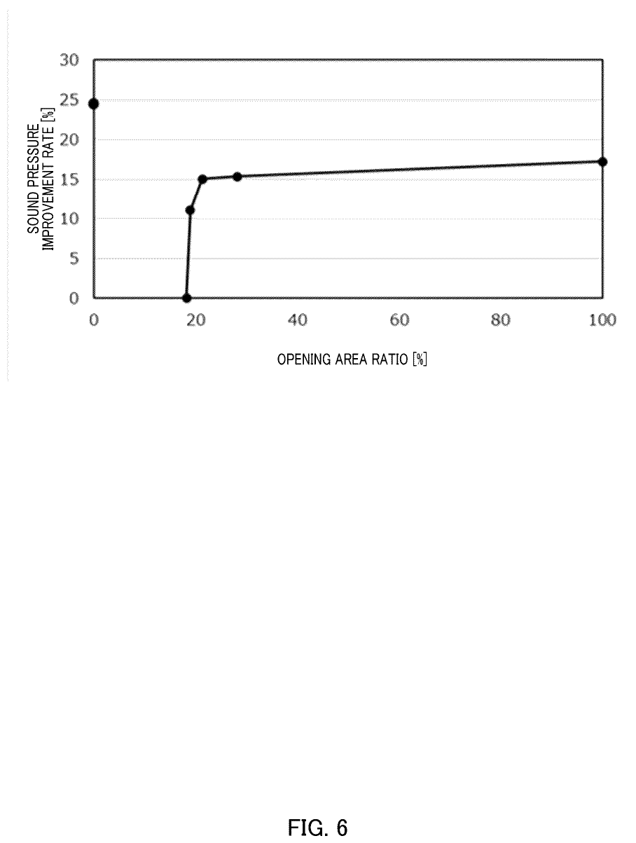

The amount of improvement in the maximum sound pressure in the frequency characteristics as in Table 2 will be described in more detail with reference to the graph in FIG. 6. According to the graph in FIG. 6, as in the graph in FIG. 5, the sound pressure improvement rate sharply increases once the opening area exceeds around 18.2%, then becomes gentler near the opening area of 21.3% corresponding to Example 2, and remains substantially flat until the opening area of 100% corresponding to Reference Example 3. As a result, it is suggested that the improvement effect on the maximum sound pressure is saturated when the opening area reaches approximately 21.3%, and that it is difficult to achieve significant improvement by further increasing the area. In addition, for example, from the graph in FIG. 6, in consideration of the balance between the sound performance and other design requirements, it is considered that the opening area range of 19% or more and 28.2% or less, in which appropriate improvement can be obtained, is a practical design choice.

According to the graph in FIG. 6, as in the graph in FIG. 5, the structure of Reference Example 1 in which there is “no gap” provides the highest sound pressure. However, achieving such a structure requires a lot of cost and effort. Therefore, providing substrate opening portion 33 in substrate 3 may be a more realistic and practical option for mass-produced products, as such a configuration has a simpler manufacturing process, is more cost-effective, and provides greater design flexibility.

TABLE 3

| | Reference | Reference | | | | Reference |
|---|---|---|---|---|---|---|
| | Example 1 | Example 2 | Example 1 | Example 2 | Example 3 | Example 3 |
| Presence or | Absence | Presence | Presence | Presence | Presence | — |
| Absence of Gap | | | | | | |
| Diameter (mm) of | — | — | φ5 | φ10 | φ25.24 | — |
| Substrate Opening | | | | | | |
| Portion 33 | | | | | | |
| Opening Area | 0 | 18.2 | 19.0 | 21.3 | 28.2 | 100 |
| Ratio [%] | | | | | | |
| Sound Pressure | 115.90 | 114.88 | 115.24 | 115.69 | 115.75 | 115.77 |
| [dBA] | | | | | | |
| Difference [dBA] | 1.02 | 0.00 | 0.36 | 0.81 | 0.87 | 0.82 |
| (ratio) with respect | (12.5%) | (0%) | (4.2%) | (9.8%) | (10.5%) | (9.9%) |
| to Reference | | | | | | |
| Example 2 | | | | | | |

The amount of improvement when the sweep control is performed such that the sound wave in the frequency range of 2.6 kHz to 3.5 kHz, which is the frequency at the time of actual use, is emitted will be described with reference to Table 3. Specifically, the change in the sound pressure level according to the different design conditions (the opening area ratio, the presence or absence of substrate 3, and the presence or absence of the substrate opening portion 33) is compared with the improvement effect with respect to Reference Example 2. This frequency range of 2.6 kHz to 3.5 kHz is a frequency band in which an acoustic device operates in an actual use environment. The frequency of 2.6 kHz is a relatively low high-pitched sound, and the frequency of 3.5 kHz is a further high-pitched sound. The frequency band is a frequency range that constitutes the core of many warning sounds, notification sounds, and acoustic signals, and is also a range to which the human auditory system is highly sensitive. Evaluating the performance in the frequency range is to confirm how effectively the device emits the sound in an actual use scene. By measuring the maximum sound pressure in an entire frequency band by the sweep control, an acoustic device can be comprehensively evaluated as to how the acoustic device radiates the acoustic energy.

In the leftmost column of Table 3, the presence or absence of the gap, the diameter (mm) of the substrate opening portion 33, and the opening area ratio [%] are the same as those in Table 1. In the leftmost column of Table 3, “sound pressure [dBA]” is the maximum sound pressure level measured when the sweep control is performed such that the sound waves having a frequency in the range from 2.6 kHz to 3.5 kHz are continuously generated, and is represented in decibels (dBA). A high sound pressure value indicates that the acoustic device is outputting a stronger sound. In the leftmost column of Table 3, the difference in maximum sound pressure [dBA] (ratio) indicates the difference in the sound pressure level when compared to Reference Example 2, and indicates the amount of improvement in the sound pressure in decibels (dBA) and the increase ratio (%) thereof. A higher numerical number means more improvement obtained for the current product.

### Reference Example 2

In Reference Example 2 in which the opening area ratio is 18.2%, the maximum sound pressure is 114.88 dBA. Other design conditions are compared with this value as a reference.

### Example 1: φ5

When the opening area ratio is 19.0%, the sound pressure reaches 115.24 dBA, and an improvement of 0.36 dBA (4.2%) is observed as compared with Reference Example 2. It can be seen that the sound pressure is improved even with a slight increase in the opening area.

### Example 2: φ10

When the opening area ratio is 21.3%, the sound pressure reaches 115.69 dBA, and an improvement of 0.81 dBA (9.8%) is confirmed as compared with Reference Example 2. It can be seen that further improvement of the sound pressure is observed by increasing the opening area.

### Example 3: φ25.24

In the housing having an opening area ratio of 28.2%, the sound pressure reaches 115.75 dBA, and an improvement of 0.87 dBA (10.5%) is confirmed as compared with Reference Example 2. When the opening area is further increased, the sound pressure improvement effect is further enhanced.

### Reference Example 3: No Substrate

In the housing in which substrate 3 is not provided, the sound pressure reaches 115.77 dBA, and an improvement of 0.89 dBA (10.8%) is observed. It can be seen that the sound pressure is further increased by the elimination of the influence of substrate 3.

### Reference Example 1: No Gap

When the gap is completely eliminated, the sound pressure reaches 115.90 dBA, and the maximum improvement of 1.02 dBA (12.5%) is confirmed with respect to Reference Example 2. In this case, since there is no sound wave leakage or resonance loss between the upper and lower cavities, it is considered that the highest sound pressure is obtained.

From Table 3, it is clear that the maximum sound pressure of acoustic device 1 in the sweep control of 2.6 kHz to 3.5 kHz is improved by increasing the opening area ratio. Although the improvement effect on the sound pressure tends to become higher as the opening area become larger, it is suggested that there is a limit to the improvement effect after the opening area is increased by a certain amount or more. In this regard, it can be seen that the above results are consistent with the results of Table 1 and the graph of FIG. 5 and the results of Table 2 and the graph of FIG. 6. In particular, the most effective is to completely eliminate the gap, and in this case, the maximum sound pressure improvement is achieved. However, as described above, since it is difficult to eliminate the gap and to bring the components into close contact with each other in manufacturing, it is considered that it is more appropriate to provide substrate opening portion 33 in substrate 3 to achieve practical and effective sound pressure improvement.

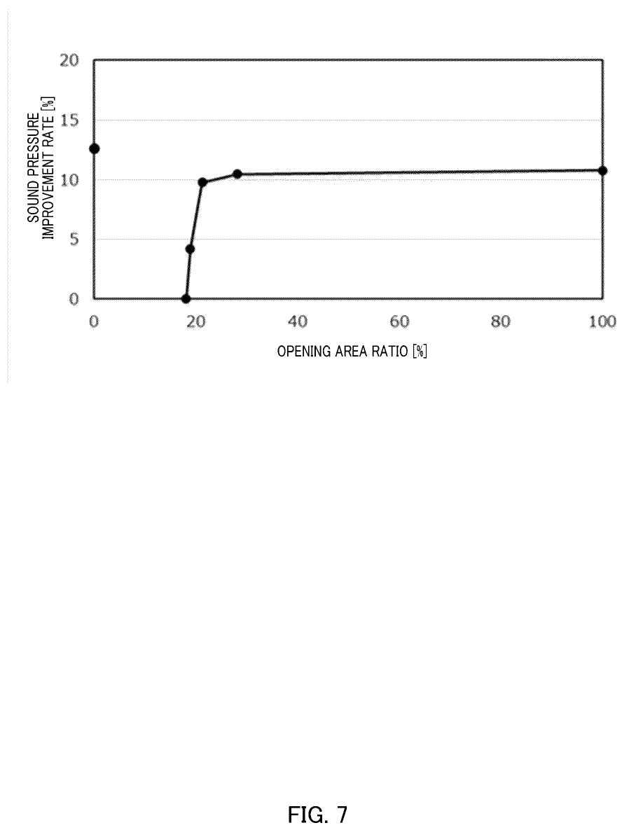

The amount of improvement of the maximum sound pressure of the frequency characteristics in the sweep control for continuously emitting sound waves in the frequency range of 2.6 kHz to 3.5 kHz as illustrated in Table 3 will be described in more detail with reference to the graph in FIG. 7. According to the graph in FIG. 6, as in the graph in FIG. 5, the sound pressure improvement rate sharply increases once the opening area exceeds around 18.2%, then becomes gentle near the opening area of 21.3% corresponding to Example 2, and remains substantially flat until the opening area of 100% corresponding to Reference Example 3. As a result, it is suggested that the improvement effect on the maximum sound pressure is saturated when the opening area reaches approximately 21.3%, and that it is difficult to achieve significant improvement by further increasing the area. In addition, for example, from the graph in FIG. 7, in consideration of the balance between the sound performance and other design requirements, it is considered that the opening area range of 19% or more and 28.2% or less, in which appropriate improvement can be obtained, is a practical design choice.

According to the graph in FIG. 7, as in the graphs in FIGS. 5 and 6, the structure of Reference Example 1 in which there is “no gap” provides the highest sound pressure. However, achieving such a structure requires a lot of cost and effort. Therefore, providing substrate opening portion 33 in substrate 3 may be a more realistic and practical option for mass-produced products, as such a configuration has a simpler manufacturing process, is more cost-effective, and provides greater design flexibility.

From the results of Tables 1 to 3 and FIGS. 5 to 7, the opening area ratio is preferably in a range of, for example, 19% or more and 28.2% or less. As a result, the design flexibility is increased, so that devices to be adjusted to different environments or the like are possible, and an acoustic device can be adjusted to have different sound characteristics. In addition, the improvement of the acoustic efficiency can be achieved by the wide range of the opening area.

In addition, the opening area ratio is preferably in a range of, for example, 19.0% or more and 21.3% or less. By setting the opening area ratio in a relatively narrow range, it is possible to more precisely control the sound characteristics. As a result, it is advantageous in a case where a specific frequency band or an acoustic effect is to be enhanced, and is optimal for device design in which the balance or quality of sound is prioritized.

Further, the opening area ratio is preferably in a range of, for example, 21.3% or more and 28.2% or less. By setting a relatively large opening area ratio, it is possible to obtain a higher sound pressure, which is suitable for a scene in which a large volume is output or a case where the sound is diffused over a wide range. In addition, ventilation and heat dissipation are also improved, increasing the durability and the stability of the device. The range is effective in a case where a powerful acoustic effect is desired. By setting the opening area ratio, the performance or the characteristic of an acoustic device is adjusted, and the optimal sound design according to the use can be realized.

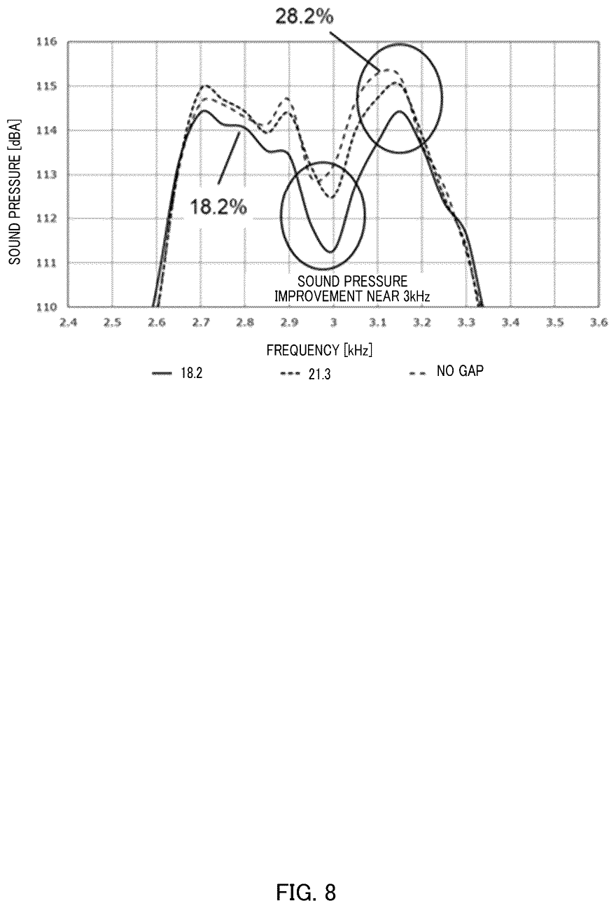

FIG. 8 is a graph illustrating a relationship between a frequency (kHz) and a sound pressure (dBA) for Reference Example 2 (opening area ratio of 18.2%) serving as a reference, Example 3 (opening area ratio of 28.2%), and Reference Example 1 (opening area ratio of 0%). In the graph, the horizontal axis represents the frequency, and fluctuations in the sound pressure are shown in a range of 2.4 kHz to 3.6 kHz. The vertical axis in the graph indicates the sound pressure level, and the dB (decibel) is indicated with respect to N (reference sound pressure).

The solid line indicates the sound pressure characteristic in a case of Reference Example 2 (opening area ratio of 18.2%) serving as a reference. A dip is observed in the vicinity of a frequency of approximately 3 kHz, and the sound pressure is decreased. In addition, peaks are observed near 2.7 kHz and 3.15 kHz.

One of the broken lines indicates the sound pressure characteristic in a case of Example 3 (opening area ratio of 28.2%). When Example 3 is compared with Reference Example 2 serving as a reference, it can be seen that the sound pressure is generally increased between the vicinity of 2.66 kHz and the vicinity of 3.27 kHz. In addition, the peak structure near 2.9 kHz is more prominent than that in Reference Example 2. Further, as in Reference Example 2, the dip is present near 3 kHz, but it can be seen that the depth of the dip near 3 kHz with respect to the peaks near 2.7 kHz and 3.15 kHz is less than that of Reference Example 2. It is considered that the presence of the peak near 2.9 kHz that becomes prominent in Example 3 fills the dip near 3 kHz. In addition, it is considered that the depth of the dip near 3 kHz is reduced by suppressing the resonance loss.

The broken line between Example 3 (opening area ratio of 28.2%) and Reference Example 2 (opening area ratio of 18.2%) indicates the sound pressure characteristic in a case of Example 2 (opening area ratio of 21.3%). The frequency characteristic indicates a frequency characteristic in which the spectrum of Reference Example 2 is strongly intensified.

From the frequency-dependent sound pressure characteristic in FIG. 8, the relationship between the increase in the opening area ratio and the sound pressure is such that the sound pressure is generally improved by increasing the opening area ratio from 18.2% to 28.2%, and a significant improvement is observed for a frequency in a range of 2.66 kHz to 3.27 kHz. As a result, the performance of acoustic device 1 is improved, and it is shown that the dip near 3 kHz is still present, but the relative depth of the dip can be reduced. Regarding the influence of the gap, it was confirmed that the loss of the sound pressure was significantly improved and the maximum sound pressure was obtained when there is no gap. This indicates that the gap may have a negative influence on the transmission of the sound, but suggests that the optimization of the opening area ratio may influence the acoustic performance. It is indicated that adjusting the opening area ratio can effectively improve the sound pressure, and the state of “no gap” corresponding to the opening area ratio of 0% achieves the results of the highest sound pressure. However, in an actual design or manufacturing process, it is not always realistic to eliminate a gap, and the adjustment of the opening area ratio to an appropriate value is desired. Such adjustment can be realized by providing substrate opening portion 33 in substrate 3. Since the approach of providing substrate opening portion 33 is simple in the manufacturing process, has high cost efficiency, and has design flexibility, the approach may be a more realistic and practical choice in the mass-produced product. Even by the method, since sufficient acoustic performance improvement that is comparable to Reference Example 1 having shown the maximum improvement rate can be obtained, it can be said that “providing the opening portion” is a better approach than “filling the gap” in the manufacturing of acoustic device 1.

### INDUSTRIAL APPLICABILITY

The present disclosure is suitable as an acoustic device that issues a warning sound.

### CROSS REFERENCE TO RELATED APPLICATIONS

This application is entitled to the benefit of Japanese Patent Application No. 2024-176462, filed on Oct. 8, 2024, the disclosures of which including the specification, drawings and abstract are incorporated herein by reference in their entirety.

### REFERENCE SIGNS LIST

1 Acoustic device
2 Housing
3 Substrate
4 Acoustic film
5 Acoustic output element
21 Upper housing
22 Lower housing
23 Inner surface
31 Outer surface
33 Substrate opening portion

1. An acoustic device comprising:
a substrate including a circuit which, in operation, generates a drive signal for generating a sound wave; and
a housing that houses the substrate inside, wherein
the substrate is provided at a position that divides a space in the housing into an upper cavity and a lower cavity,
the upper cavity and the lower cavity communicate with each other through an opening portion, and
the opening portion includes a substrate opening portion that penetrates the substrate.

2. The acoustic device according to claim 1, wherein
the opening portion includes a gap between an inner surface of the housing and the substrate.

3. The acoustic device according to claim 2, wherein
an opening area ratio that is a ratio of an area of the opening portion to an area of a space surrounded by the inner surface of the housing is 19% or more and 28.2% or less, the opening portion being composed of the substrate opening portion and the gap.

4. The acoustic device according to claim 2, wherein
an opening area ratio that is a ratio of an area of the opening portion to an area of a space surrounded by the inner surface of the housing is 19.0% or more and 21.3% or less, the opening portion being composed of the substrate opening portion and the gap.

5. The acoustic device according to claim 2, wherein
an opening area ratio that is a ratio of an area of the opening portion to an area of a space surrounded by the inner surface of the housing is 21.3% or more and 28.2% or less, the opening portion being composed of the substrate opening portion and the gap.

6. The acoustic device according to claim 1, wherein
the substrate opening portion has a circular shape.

7. The acoustic device according to claim 1, wherein
the substrate opening portion has a polygonal shape.

8. The acoustic device according to claim 1, wherein
a plurality of the substrate opening portions are provided.

9. The acoustic device according to claim 1, wherein
the substrate opening portion is provided at a center portion of the substrate.

10. The acoustic device according to claim 1, further comprising:
an acoustic output element that emits a sound wave having a frequency of 3 kHz.

11. The acoustic device according to claim 1, further comprising:
an acoustic film including a protrusion for suppressing transmission of a vibration to the housing.
